(19) United States
(12) Patent Application Publication
(10) Pub. No.: US 2026/0016188 A1
(43) Pub. Date: Jan. 15, 2026

(54) Dust Filter Attachment Device

(71) Applicant: Geraldine Craig, Daphne, AL (US)

(72) Inventor: Geraldine Craig, Daphne, AL (US)

(21) Appl. No.: 19/256,598

(22) Filed: Jul. 1, 2025

Related U.S. Application Data
(60) Provisional application No. 63/668,804, filed on Jul. 9, 2024.

(51) Int. Cl. F24F 13/28; B01D 46/00; F24F 8/108; F24F 8/50

(52) U.S. Cl. CPC F24F 13/28; B01D 46/001; B01D 46/0015; B01D 46/0038; F24F 8/108; F24F 8/50; B01D 2279/50

(57) ABSTRACT

A dust filter attachment device is disclosed, which is a dust filter attachment for an HVAC system. The dust filter attachment device comprises a perimeter frame configured in various shapes to accommodate a variety of air vent openings. The perimeter frame comprises an open center region which comprises a porous fabric configured to collect dust. An interior side of the perimeter frame includes a plurality of magnetic fasteners which are adhered to the interior side of the perimeter frame. The magnetic fasteners releasably secure the device to an exterior frame of an air return vent.

### CROSS-REFERENCE TO RELATED APPLICATION

The present application claims priority to, and the benefit of, U.S. Provisional Application No. 63/668,804, which was filed on Jul. 9, 2024, and is incorporated herein by reference in its entirety.

### FIELD OF THE INVENTION

The present invention relates generally to the field of dust filter attachment devices. More specifically, the present invention relates to a dust filter attachment for an HVAC system. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in dust filter attachment devices. Generally, many homes, schools, and other buildings utilize HVAC systems which disperse air through the building. Typically, dust can be collected due to the flow of air through the HVAC system, causing the dust to accumulate within the air ducts of the HVAC system, which can require frequent cleaning to prevent blockages or dangerous buildup. Additionally, HVAC systems can stir up and distribute airborne dust through the building, thereby aggravating allergies. Therefore, a device that can filter dust from the air being distributed through an HVAC system is desired.

Current products do not offer an external easy on easy off air duct filter system. The current air filter systems are typically located on the air intake or under the duct registers faceplate. Further, current HVAC systems have the air filters at the intake portion of the furnace and/or the air-conditioning handler. This system allows for dust and dirt, which may be in the duct system to be filtered at every air duct exit vent plate fascia. What is needed is a duct filter which collects dust particulates within the circulated air and prevents the dust from collecting within the HVAC system or being further distributed throughout the building.

Accordingly, there is a demand for an improved dust filter attachment device that provides a dust filter attachment for an HVAC system. More particularly, there is a demand for a dust filter attachment device that is positioned within the air return vent, thus forcing circulated air through the porous material of the device to collect dust particulates.

Therefore, there exists a long-felt need in the art for a dust filter attachment device that provides users with a dust filter attachment for an HVAC system. There is also a long-felt need in the art for a dust filter attachment device that includes a perimeter frame having an open center region. Further, there is a long-felt need in the art for a dust filter attachment device that features porous fabric disposed within the open center region of the frame. Moreover, there is a long-felt need in the art for a device that includes an air freshener secured to the perimeter frame. Further, there is a long-felt need in the art for a dust filter attachment device that includes magnetic fasteners for easy removal. Finally, there is a long-felt need in the art for a dust filter attachment device that secures to the exterior frame of an air return vent.

The subject matter disclosed and claimed herein, in one embodiment thereof, comprises a dust filter attachment device. The device is a dust filter attachment for an HVAC system. The dust filter attachment device comprises a perimeter frame configured in various shapes to accommodate a variety of air vent openings. The perimeter frame comprises an open center region which comprises a porous fabric configured to collect dust. An interior side of the perimeter frame includes a plurality of magnetic fasteners which are adhered to the interior side of the perimeter frame. The magnetic fasteners releasably secure the device to an exterior frame of an air return vent. Further, the perimeter frame and/or the porous fabric can include an air freshener or be impregnated with an air freshener scent to distribute a pleasant smell throughout the building.

In this manner, the dust filter attachment device of the present invention accomplishes all of the foregoing objectives and provides users with a dust filter for an HVAC system. The device is available in multiple shapes for different sized air vents. The device is typically secured to an air return vent.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dust filter attachment device. The device is a dust filter attachment for an HVAC system. The dust filter attachment device comprises a perimeter frame configured in various shapes to accommodate a variety of air vent openings. The perimeter frame comprises an open center region which comprises a porous fabric configured to collect dust. Fasteners releasably secure the device to an exterior frame of an air return vent or other suitable spot within a building.

In one embodiment, the dust filter attachment device is non-invasive and does not require assembly. This unique device works in conjunction with most wall, ceiling, and dashboard fuchsia vent duct covers. This versatile multi-functional device will adhere to metal or non-metal surfaces and will work with a variety of stock factory air duct systems vents. Further, the dust filter attachment device is used as an after-market item and is affixed to vent outlets (i.e., openings in current, metal, or non-metal plate factory or stock air vents of various shapes).

In one embodiment, when the dust filter attachment device becomes dirty, they are easily changeable or exchangeable, for a new and clean device. Further, the dust filter attachment device can be removed, cleaned, and re-used on a regular basis, as well, depending on the needs and/or wants of a user.

In one embodiment, the dust filter attachment device comprises a perimeter frame. The perimeter frame can comprise a variety of shapes and sizes to fit a variety of air vent openings. Specifically, the perimeter frame can comprise a variety of cross-sectional areas to accommodate the variety of air vent openings. The figures disclose a rectangular configuration for the perimeter frame.

In one embodiment, the perimeter frame comprises four frame components secured together in a rectangular configuration. The perimeter frame comprises an exterior side which faces out into the room and an interior side which faces toward the air vent opening, opposing side walls, and opposing top and bottom walls.

In one embodiment, the perimeter frame comprises an open center region. The open center region comprises porous fabric stretched across to cover the entire open center region. The porous fabric acts to collect dust particulates and other particulates from the air as it enters the air return vent. In use, the device fits on top of a vent register, and the perimeter frame is contoured to fit with a register so that the device blends to appear like the register.

In one embodiment, the interior side of the perimeter frame contains a fastener secured along the frame. Typically, magnets are secured to the interior side of the perimeter frame. In this embodiment, the magnets have an adhesive side which is applied to the interior side of the perimeter frame, securing the magnetic fasteners in place. Any suitable number of magnets can be secured to the perimeter frame. For example, the magnets can be placed around the entire perimeter frame or on only select portions. Typically, the adhesive side of the magnets comprise a release liner or other removable liner that is removed to allow the magnets to be affixed to the interior side of the perimeter frame. Once in place, the magnets allow the perimeter frame to be removably secured to the air return vent. Specifically, the perimeter frame can be applied to the outside of the grate or louvers, or the grate or louvers can be removed and the perimeter frame is applied directly to the air duct, itself.

In one embodiment, any suitable fasteners can be secured to the perimeter frame, such as magnets, adhesives, or press fit, etc., can be utilized to releasably secure the device to the air duct. Further, other fasteners besides magnetic fasteners can be used to adhere the device to any non-metal surfaces like plastic or drywall, depending on the shape and size of the air duct and the shape and size of the device in use.

In one embodiment, the dust filter attachment device is an aftermarket air filter system, which is accessible and user friendly. Also, in the case of a non-magnet to metal contact adhesion compatibility such as ceiling, car vinyl dashboards, aircraft overhead vents, flooring, and any forced air duct exits, there may be no metal for the magnetic to attach, an adhesive may be incorporated.

In yet another embodiment, on an HVAC filter, the perimeter frame is attached to the grate by a mechanical means. For example, this could be done with screws, clips, magnets, snap on fit or friction fit, or any combination thereof as may be suitable for a particular application.

In one embodiment, the dust filter attachment device includes an air freshener removably secured to a part of the perimeter frame. The air freshener can be any suitable air freshener as is known in the art. The air freshener can be positioned on any suitable place of the perimeter frame. Further, the air freshener can be secured via any suitable securing means as is known in the art. The air freshener is positioned on the perimeter frame, such that air passing through the perimeter frame distributes the scent of the air freshener through the HVAC system. In another embodiment, the porous fabric is impregnated with an air freshener scent. The impregnated porous fabric allows the air passing through the porous fabric to distribute the scent. The impregnated or scent infused porous fabric is able to disperse various or independent scents room to room.

In one embodiment, the dust filter attachment device allows for a non-restrictive in-take airflow of the HVAC furnace or AC handler. This device also creates a non-restrictive in or out-put airflow from the duct vents.

In one embodiment, the perimeter frame of the dust filter attachment device prevents bulging, which would allow dust and dirt or mold to escape around the porous fabric. Further, the device also prevents blowing out and/or away, or bunching between the duct vent plate due to the semi-rigid perimeter frame.

In one embodiment, the device disclosed herein can be used on both the supply and/or return side of HVAC systems. Similarly, it could be used in other air moving applications not related to HVAC such as cooling fans on computers and other electrical equipment. It could also be applied to air exchange in kitchen and cooking applications where particulate matter and dissolved gasses in the air can be effectively filtered.

In operation, the perimeter frame of the device is dimensioned to completely cover a predetermined grate on an HVAC system. These can range from a few inches across to several feet or large in most applications. The frame has a margin that is in continuous and airtight contact with the grate. Essentially, the frame holds the filter against the grate. The grate is an existing part of the HVAC system. The porous fabric is dimensioned to match the dimensions of the perimeter frame's center region so that they are typically about the same size. The porous fabric is configured so that an airborne particulate is captured and held by the fabric. The porous fabric could be designed to capture 0.5 microns or less or could be made to capture anything above a preset point, for example, 5 microns or larger. By adapting the size of the particles captures the porous fabric's resistance or flow through rate can be adjusted as well as the size of material that is picked up by the fabric.

Generally, the invention provides the elimination or reduction in harsh breathable elements and clean air. The device is placed in a key location that is most sensible when desiring to be most effective while producing a second source of defense against foreign elements that cause so many to either suffer or constantly purchase items to refresh their living space. Even with an HVAC home filter, air becomes dirty and potentially can allow dirt particles and dust the chance of entering the air duct system. In addition, in some living and workspaces, there is no access to the system and main filter so that one does not know if the filter is clean or not. For example, typically in apartment living, the occupants do not maintain the filter, so they do not know if the air is clean or not. The dust that makes it past the filter comes to rest inside the air duct system or enters into the living space. The disclosed device provides an attachable filter set to filter all the things that the main filter does not filter. The room is refreshed while this process takes place. Further, one has the capability of releasing various scents to also refresh the room. Thus, it can be seen that a simple, add-on filter can be had according to the invention that will work universally on apartments, homes, offices, workspaces, etc., to assure clean air. The device can be decorative, practical, and easy to use.

In one embodiment, the porous fabric is manufactured from tulle, cellulose, fiberglass, synthetic polymers, charcoal, synthetic fibers, or other suitable materials as is known in the art, or a combination of such materials. Further, the porous fabric is a non-ridged single or multi-layer structure. In one embodiment, the porous fabric is constructed from a static charged, synthetic fibrous non-woven material like “Swifter” floor dusting pads. This electrostatic charge aids the fabric in attracting and collecting from the air many airborne particulates such as dust, odor causing particles, dander, and many other floating matter that could otherwise potentially pass through the HVAC system and be readmitted to the breathing air. Specifically, the porous fabric acts to collect and trap airborne dust, hair, dirt, mold, and pollen spores, etc. The porous fabric could also use an activated carbon element to further capture particulate matter, odors, chemical vapors (such as organic compounds), and other matter carried by or dissolved in the air passing through the device.

In yet another embodiment, the dust filter attachment device comprises a plurality of indicia.

In yet another embodiment, a method of filtering dust for an HVAC system is disclosed. The method includes the steps of providing a dust filter attachment device comprising a perimeter frame with a porous fabric attached to the open center region. The method also comprises securing an air freshener to the perimeter frame. Further, the method comprises impregnating the porous fabric with a pleasant scent. The method also comprises securing the device to an exterior frame of an air return vent via the magnetic fasteners. Finally, the method comprises replacing the dust filter attachment device when dirty.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the dust filter attachment device of the present invention in accordance with the disclosed architecture;

FIG. 2 illustrates a rear perspective view of one embodiment of the dust filter attachment device of the present invention showing the fasteners positioned on the back side in accordance with the disclosed architecture;

FIG. 3 illustrates a perspective view of one embodiment of the dust filter attachment device of the present invention showing the device in use in accordance with the disclosed architecture;

FIG. 4 illustrates a perspective view of one embodiment of the dust filter attachment device of the present invention showing the porous fabric in accordance with the disclosed architecture;

FIG. 5 illustrates a rear perspective view of one embodiment of the dust filter attachment device of the present invention showing the fasteners positioned on the back side in accordance with the disclosed architecture; and

FIG. 6 illustrates a flowchart showing the method of filtering dust for an HVAC system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a dust filter attachment device that provides users with a dust filter attachment for an HVAC system. There is also a long-felt need in the art for a dust filter attachment device that includes a perimeter frame having an open center region. Further, there is a long-felt need in the art for a dust filter attachment device that features porous fabric disposed within the open center region of the frame. Moreover, there is a long-felt need in the art for a device that includes an air freshener secured to the perimeter frame. Further, there is a long-felt need in the art for a dust filter attachment device that includes magnetic fasteners for easy removal. Finally, there is a long-felt need in the art for a dust filter attachment device that secures to the exterior frame of an air return vent.

The present invention, in one exemplary embodiment, is a novel dust filter attachment device. The device is a dust filter attachment for an HVAC system. The dust filter attachment device comprises a perimeter frame configured in various shapes to accommodate a variety of air vent openings. The perimeter frame comprises an open center region which comprises a porous fabric configured to collect dust. An interior side of the perimeter frame includes a plurality of magnetic fasteners which are adhered to the interior side of the perimeter frame. The magnetic fasteners releasably secure the device to an exterior frame of an air return vent. Further, the perimeter frame and/or the porous fabric can include an air freshener or be impregnated with an air freshener scent to distribute a pleasant smell throughout the building. The present invention also includes a novel method of filtering dust for an HVAC system. The method includes the steps of providing a dust filter attachment device comprising a perimeter frame with a porous fabric attached to the open center region. The method also comprises securing an air freshener to the perimeter frame. Further, the method comprises impregnating the porous fabric with a pleasant scent. The method also comprises securing the device to an exterior frame of an air return vent via the magnetic fasteners. Finally, the method comprises replacing the dust filter attachment device when dirty. The device may also be used on the air filter panel door. Further, the device may act as a pillow-case type of cover over the air filter. This will reduce the cost of replacing air filters as the device can be rinsed and reused.

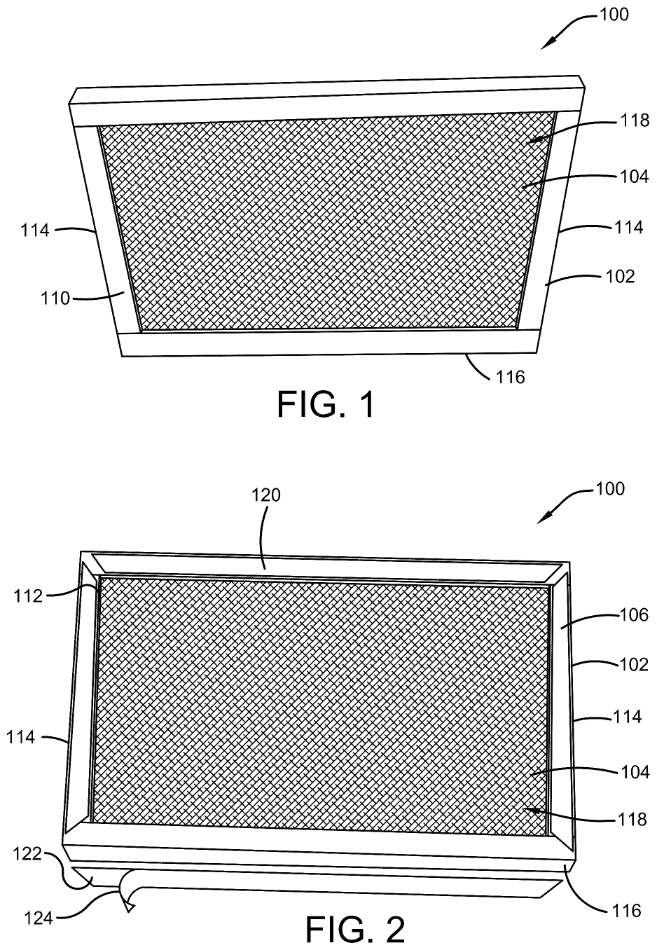

Referring initially to the drawings, FIG. 1 illustrates a perspective view of one embodiment of the dust filter attachment device 100 of the present invention. In the present embodiment, the dust filter attachment device 100 is an improved dust filter attachment device 100 that provides a user with a filter for an HVAC system. Specifically, the dust filter attachment device 100 comprises a perimeter frame 102 with a porous fabric 104 for filtering dust particulates. Fasteners 106 releasably secure the device 100 to an exterior frame of an air return vent 108 or other suitable spot within a building.

Generally, the dust filter attachment device 100 is non-invasive and does not require assembly. This unique device 100 works in conjunction with most wall, ceiling, and dashboard fuchsia vent duct covers. This versatile multi-functional device 100 will adhere to metal or non-metal surfaces and will work with a variety of stock factory air duct systems vents. Further, the dust filter attachment device 100 is used as an after-market item and is affixed to vent outlets 108 (i.e., openings in current, metal, or non-metal plate factory or stock air vents of various shapes).

Further, when the dust filter attachment device 100 becomes dirty, they are easily changeable or exchangeable, for a new and clean device 100. Further, the dust filter attachment device 100 can be removed, cleaned, and re-used on a regular basis, as well, depending on the needs and/or wants of a user.

Additionally, the dust filter attachment device 100 comprises a perimeter frame 102. The perimeter frame 102 can comprise a variety of shapes and sizes to fit a variety of air vent openings. Specifically, the perimeter frame 102 can comprise a variety of cross-sectional areas to accommodate the variety of air vent openings. The figures disclose a rectangular configuration for the perimeter frame 102.

In one embodiment, the perimeter frame 102 comprises four frame components secured together in a rectangular configuration. The perimeter frame 102 comprises an exterior side 110 which faces out into the room and an interior side 112 which faces toward the air vent opening, opposing side walls 114, and opposing top and bottom walls 116.

In one embodiment, the perimeter frame 102 comprises an open center region 118. The open center region 118 comprises porous fabric 104 stretched across to cover the entire open center region 118. The porous fabric 104 acts to collect dust particulates and other particulates from the air as it enters the air return vent 108. In use, the device 100 fits on top of a vent register, and the perimeter frame 102 is contoured to fit with a register, so that the device 100 blends to appear like the register.

As shown in FIG. 2, the interior side 112 of the perimeter frame 102 contains a fastener 106 secured along the frame 102. Typically, magnets 120 are secured to the interior side 112 of the perimeter frame 102. In this embodiment, the magnets 120 have an adhesive side 122 which is applied to the interior side 112 of the perimeter frame 102, securing the magnetic fasteners 120 in place. Any suitable number of magnets 120 can be secured to the perimeter frame 102. For example, the magnets 120 can be placed around the entire perimeter frame 102 or on only select portions. Typically, the adhesive side 122 of the magnets 120 comprise a release liner 124 or other removable liner that is removed to allow the magnets 120 to be affixed to the interior side 112 of the perimeter frame 102. Once in place, the magnets 120 allow the perimeter frame 102 to be removably secured to the air return vent 108. Specifically, the perimeter frame 102 can be applied to the outside of the grate or louvers, or the grate or louvers can be removed and the perimeter frame 102 is applied directly to the air duct 108, itself.

In one embodiment, any suitable fasteners 106 can be secured to the perimeter frame 102, such as magnets 120, adhesives, or press fit, etc., can be utilized to releasably secure the device 100 to the air duct 108. Further, other fasteners 106 besides magnetic fasteners 120 can be used to adhere the device 100 to any non-metal surfaces like plastic or drywall, depending on the shape and size of the air duct 108 and the shape and size of the device 100 in use.

Furthermore, the dust filter attachment device 100 is an aftermarket air filter system, which is accessible and user friendly. Also, in the case of a non-magnet to metal contact adhesion compatibility such as ceiling, car vinyl dashboards, aircraft overhead vents, flooring, and any forced air duct exits, there may be no metal for the magnetic to attach, an adhesive may be incorporated.

In yet another embodiment, on an HVAC filter, the perimeter frame 102 is attached to the grate by a mechanical means. For example, this could be done with screws, clips, magnets, snap on fit or friction fit, or any combination thereof as may be suitable for a particular application.

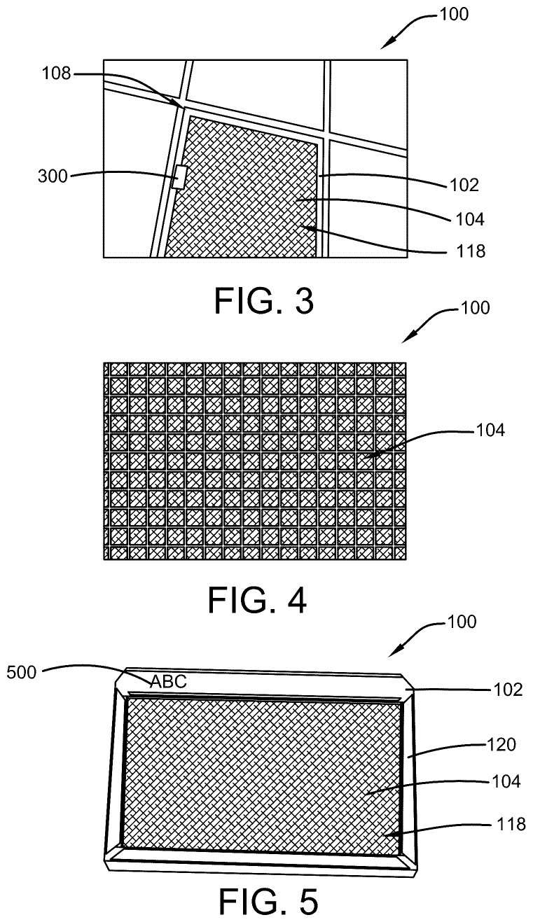

As shown in FIG. 3, the dust filter attachment device 100 includes an air freshener 300 removably secured to a part of the perimeter frame 102. The air freshener 300 can be any suitable air freshener as is known in the art. The air freshener 300 can be positioned on any suitable place of the perimeter frame 102. Further, the air freshener 300 can be secured via any suitable securing means as is known in the art. The air freshener 300 is positioned on the perimeter frame 102, such that air passing through the perimeter frame 102 distributes the scent of the air freshener 300 through the HVAC system. In another embodiment, the porous fabric 104 is impregnated with an air freshener scent. The impregnated porous fabric 104 allows the air passing through the porous fabric 104 to distribute the scent. The impregnated or scent infused porous fabric 104 is able to disperse various or independent scents room to room.

In one embodiment, the perimeter frame 102 of the dust filter attachment device 100 prevents bulging, which would allow dust and dirt or mold to escape around the porous fabric 104. Further, the device 100 also prevents blowing out and/or away, or bunching between the duct vent plate due to the semi-rigid perimeter frame 102.

Generally, the device 100 disclosed herein can be used on both the supply and/or return side of HVAC systems. Similarly, it could be used in other air moving applications not related to HVAC such as cooling fans on computers and other electrical equipment. It could also be applied to air exchange in kitchen and cooking applications where particulate matter and dissolved gasses in the air can be effectively filtered.

As shown in FIG. 4, the dust filter attachment device 100 allows for a non-restrictive in-take airflow of the HVAC furnace or AC handler. This device 100 also creates a non-restrictive in or out-put airflow from the duct vents 108.

In one embodiment, the porous fabric 104 is manufactured from tulle, cellulose, fiberglass, synthetic polymers, charcoal, synthetic fibers, or other suitable materials as is known in the art, or a combination of such materials. Further, the porous fabric 104 is a non-ridged single or multi-layer structure. In one embodiment, the porous fabric 104 is constructed from a static charged, synthetic fibrous non-woven material like “Swifter” floor dusting pads. This electrostatic charge aids the fabric 104 in attracting and collecting from the air many airborne particulates such as dust, odor causing particles, dander, and many other floating matter that could otherwise potentially pass through the HVAC system and be readmitted to the breathing air. Specifically, the porous fabric 104 acts to collect and trap airborne dust, hair, dirt, mold and pollen spores, etc. The porous fabric 104 could also use an activated carbon element to further capture particulate matter, odors, chemical vapors (such as organic compounds), and other matter carried by or dissolved in the air passing through the device 100.

As shown in FIG. 5, in operation, the perimeter frame 102 of the device 100 is dimensioned to completely cover a predetermined grate on an HVAC system. These can range from a few inches across to several feet or large in most applications. The frame 102 has a margin that is in continuous and airtight contact with the grate. Essentially, the frame 102 holds the filter against the grate. The grate is an existing part of the HVAC system. The porous fabric 104 is dimensioned to match the dimensions of the perimeter frame's center region 118 so that they are typically about the same size. The porous fabric 104 is configured so that an airborne particulate is captured and held by the fabric 104. The porous fabric 104 could be designed to capture 0.5 microns or less or could be made to capture anything above a preset point, for example, 5 microns or larger. By adapting the size of the particles captures the porous fabric's resistance or flow through rate can be adjusted as well as the size of material that is picked up by the fabric 104.

Generally, the invention provides the elimination or reduction in harsh breathable elements and clean air. The device 100 is placed in a key location that is most sensible when desiring to be most effective while producing a second source of defense against foreign elements that cause so many to either suffer or constantly purchase items to refresh their living space. Even with an HVAC home filter, air becomes dirty and potentially can allow dirt particles and dust the chance of entering the air duct system. In addition, in some living and workspaces, there is no access to the system and main filter so that one does not know if the filter is clean or not. For example, typically in apartment living, the occupants do not maintain the filter, so they do not know if the air is clean or not. The dust that makes it past the filter comes to rest inside the air duct system or enters into the living space. The disclosed device 100 provides an attachable filter set to filter all the things that the main filter does not filter. The room is refreshed while this process takes place. Further, one has the capability of releasing various scents to also refresh the room. Thus, it can be seen that a simple, add-on filter can be had according to the invention that will work universally on apartments, homes, offices, workspaces, etc., to assure clean air. The device 100 can be decorative, practical, and easy to use.

In yet another embodiment, the dust filter attachment device 100 comprises a plurality of indicia 500. The perimeter frame 102 of the device 100 may include advertising, a trademark, or other letters, designs, or characters, printed, painted, stamped, or integrated into the perimeter frame 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be dust filter, HVAC, or brand related.

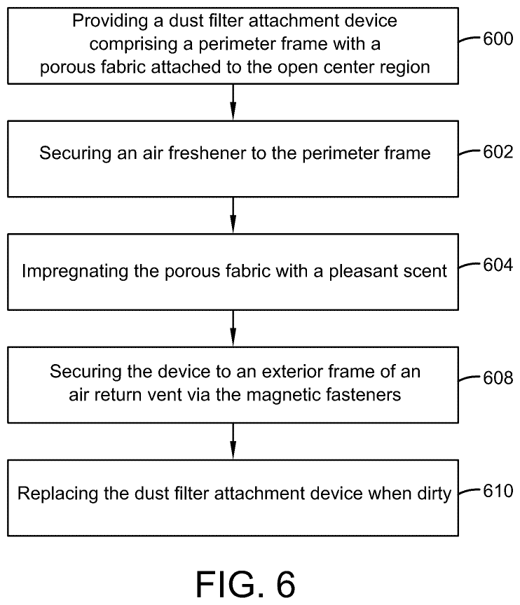

FIG. 6 illustrates a flowchart of the method of filtering dust for an HVAC system. The method includes the steps of at 600, providing a dust filter attachment device comprising a perimeter frame with a porous fabric attached to the open center region. The method also comprises at 602, securing an air freshener to the perimeter frame. Further, the method comprises at 604, impregnating the porous fabric with a pleasant scent. The method also comprises at 606, securing the device to an exterior frame of an air return vent via the magnetic fasteners. Finally, the method comprises at 608, replacing the dust filter attachment device when dirty.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “dust filter attachment device”, “dust filter device”, “attachment device”, and “device” are interchangeable and refer to the dust filter attachment device 100 of the present invention.

Notwithstanding the foregoing, the dust filter attachment device 100 of the present invention can be of any suitable size and configuration as is known in the art without affecting the overall concept of the invention, provided that it accomplishes the above-stated objectives. One of ordinary skill in the art will appreciate that the dust filter attachment device 100 as shown in FIGS. 1-6 is for illustrative purposes only, and that many other sizes and shapes of the dust filter attachment device 100 are well within the scope of the present disclosure. Although the dimensions of the dust filter attachment device 100 are important design parameters for user convenience, the dust filter attachment device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dust filter attachment device that provides a user with a means for filtering dust particulates, the dust filter attachment device comprising:
a perimeter frame; and
a porous fabric; and
wherein the porous fabric is secured to the perimeter frame;
wherein the perimeter frame is configured in a rectangular shape;
wherein fasteners releasably secure the perimeter frame to an air return vent; and
further wherein the porous fabric acts to filter out dust particulates from air entering the air return vent.

2. The dust filter attachment device of claim 1, wherein the dust filter attachment devices are disposable after use.

3. The dust filter attachment device of claim 2, wherein the dust filter attachment devices can be removed, cleaned, and re-used on a regular basis.

4. The dust filter attachment device of claim 3, wherein the perimeter frame can comprise a variety of shapes and sizes to fit a variety of air vent openings.

5. The dust filter attachment device of claim 4, wherein the perimeter frame comprises an exterior side which faces out into a room and an interior side which faces toward the air vent opening, opposing side walls, and opposing top and bottom walls.

6. The dust filter attachment device of claim 5, wherein the perimeter frame comprises an open center region.

7. The dust filter attachment device of claim 6, wherein the open center region comprises the porous fabric stretched across to cover an entire open center region creating a filter.

8. The dust filter attachment device of claim 7, wherein the porous fabric acts to collect dust particulates and other particulates from the air as it enters the air return vent.

9. The dust filter attachment device of claim 8, wherein the interior side of the perimeter frame contains a magnetic fastener secured along the perimeter frame.

10. The dust filter attachment device of claim 9, wherein the perimeter frame includes an air freshener removably secured to it.

11. The dust filter attachment device of claim 10, wherein the porous fabric is impregnated with an air freshener scent.

12. The dust filter attachment device of claim 11, wherein the porous fabric is manufactured from tulle, cellulose, fiberglass, synthetic polymers, charcoal, synthetic fibers, or combinations thereof.

13. The dust filter attachment device of claim 12, wherein the porous fabric is manufactured from a static charged, synthetic fibrous non-woven material to aid the porous fabric in attracting and collecting from the air many airborne particulates such as dust, odor causing particles, dander and many other floating matter that could otherwise potentially pass through the HVAC system and be readmitted to breathing air.

14. A dust filter attachment device that provides a user with a means for filtering dust particulates, the dust filter attachment device comprising:
a perimeter frame comprising an exterior side which faces out into a room and an interior side which faces toward the air vent opening, opposing side walls, and opposing top and bottom walls and an open center region; and
a porous fabric stretched across to cover entire open center region creating a filter; and
wherein the perimeter frame is configured in a rectangular shape;
wherein the interior side of the perimeter frame contains a magnetic fastener secured along the perimeter frame via adhesive backings on the magnetic fastener;
wherein the magnetic fastener releasably secures the perimeter frame to an air return vent;
wherein the porous fabric acts to filter out dust particulates from air entering the air return vent;
wherein the perimeter frame includes an air freshener removably secured to it;
wherein the porous fabric is impregnated with an air freshener scent; and
further wherein the porous fabric is manufactured from tulle, cellulose, fiberglass, synthetic polymers, charcoal, synthetic fibers, or combinations thereof.

15. The dust filter attachment device of claim 14, wherein the perimeter frame prevents bulging, which would allow dust and dirt or mold to escape around the porous fabric.

16. The dust filter attachment device of claim 14, wherein the dust filter attachment device can be used on both supply and/or return side of HVAC systems.

17. The dust filter attachment device of claim 14, wherein the dust filter attachment device allows for a non-restrictive in-take airflow of the HVAC system.

18. The dust filter attachment device of claim 14, wherein other fasteners are used, such as adhesives, screws, clips, or press fit.

19. The dust filter attachment device of claim 14 further comprising a plurality of indicia.

20. A method of filtering dust for an HVAC system, the method comprising the following steps:
providing a dust filter attachment device comprising a perimeter frame with a porous fabric attached to the open center region;
securing an air freshener to the perimeter frame;
impregnating the porous fabric with a pleasant scent;
securing the device to an exterior frame of an air return vent via the magnetic fasteners; and
replacing the dust filter attachment device when dirty.
